(19) United States
(12) Patent Application Publication
(10) Pub. No.: US 2024/0411092 A1
(43) Pub. Date: Dec. 12, 2024

(54) OPTICAL MODULE AND OPTICAL MODULE MANUFACTURING METHOD

(71) Applicant: NEC Corporation, Minato-ku, Tokyo (JP)

(72) Inventors: Taro KANEKO, Tokyo (JP); Rintaro NOMURA, Tokyo (JP)

(73) Assignee: NEC Corporation, Minato-ku, Tokyo (JP)

(21) Appl. No.: 18/690,363

(22) PCT Filed: Sep. 24, 2021
(86) PCT No.: PCT/JP2021/035096

§ 371 Date: Mar. 8, 2024

(51) Int. Cl. G02B 6/42; G02B 6/13; G02B 6/43

(52) U.S. Cl. CPC G02B 6/4206; G02B 6/13; G02B 6/43

(57) ABSTRACT

An optical module includes a lens having a first optical axis; an optical substrate having a rectangular external shape including a first side and a second side forming a right angle to each other; an optical waveguide that is formed on the optical substrate and is optically coupled, in a cross section including the first side of the optical substrate, with a second optical axis forming a predetermined angle to the first optical axis; and a package that includes a storage region having a rectangular upper surface and stores the lens and the optical substrate, wherein the lens and the optical substrate are optically coupled, and both the second side and the first optical axis are substantially parallel to one side of the rectangular storage region.

### TECHNICAL FIELD

The present invention relates to an optical module and a manufacturing method of an optical module. The present invention relates to, particularly, an optical module including a lens and an optical waveguide, and a manufacturing method of an optical module.

### BACKGROUND ART

An optical waveguide formed on an optical substrate is incorporated in an optical module and used as an optical modulator and an optical amplifier. In contrast, with increase of large-scale and high-functional optical communication devices, size reduction is required for an optical module to be used in an optical communication device. Therefore, even when an optical module including an optical waveguide is designed, an optical substrate is desirably disposed in such a way that the optical module has a small size.

FIG. 6 is a plan view schematically illustrating an internal configuration of a general optical module 900. The optical module 900 includes an optical substrate 920 and a lens 910. The optical substrate 920 and the lens 910 are mounted on a storage region 931 inside a package 930.

The optical substrate 920 is a rectangular substrate having a short side 922 and a long side 923 and internally includes an optical waveguide 925. The optical waveguide 925 is formed obliquely to the long side 923 of the optical substrate 920 in order to reduce reflection return light from an end surface on the short side 922 of the optical substrate 920. The optical substrate 920 incudes, in order to drive the optical waveguide 925, a plurality of electrodes 940 formed on the long side of the optical substrate 920. The plurality of electrodes 940 and a plurality of electrodes 941 included in the storage region 931 are connected by a plurality of wirings 942.

An optical axis 911 of the lens 910 is illustrated by a dashed-dotted line in FIG. 6. The lens 910 is disposed in such a way that the optical axis 911 is parallel to the long side 932 of the storage region 931 illustrated by a rectangle in FIG. 6. Light emitted from the optical waveguide 925 is coupled with the lens 910 and travels in a direction of the optical axis 911 parallel to the long side 932 of the storage region 931.

Techniques described in PTL 1 and PTL 2 are known as a reference literature of the present invention.

### CITATION LIST

### Patent Literature

PTL 1: Japanese Unexamined Patent Application Publication No. 2011-075978

PTL 2: Japanese Unexamined Patent Application Publication No. 2003-241005

### SUMMARY OF INVENTION

### Technical Problem

As illustrated in FIG. 6, the optical waveguide 925 is not perpendicular to the short side 922 of the optical substrate 920, and therefore an optical axis of light to be output from the optical waveguide 925 has a direction not perpendicular to the short side 922 due to refraction. In order to couple such light having an optical axis of a direction not perpendicular to the short side 922 with the lens 910, as illustrated in FIG. 6, it is necessary to dispose the optical substrate 920 obliquely to the long side 932 inside the storage region 931. Based on such disposition, light to be output from the optical waveguide 925 can be coupled with the lens 910 with low loss.

However, when the optical substrate 920 is inclined to the long side 932 of the storage region 931 in this manner, the optical substrate 920 is disposed in a region illustrated by a dashed line in FIG. 6. As a result, a width (a length in a direction perpendicular to the long side 932 in FIG. 6) of the storage region 931 is increased, and then a problem that size reduction of the optical module 900 is difficult is produced.

### OBJECT OF INVENTION

An object of the present invention is to provide a technique for reducing a size of an optical module including an optical waveguide.

### Solution to Problem

An optical module according to the present invention includes:
a lens having a first optical axis;
an optical substrate having a rectangular external shape including a first side and a second side forming a right angle to each other;
an optical waveguide that is formed on the optical substrate and is optically coupled, in a cross section including the first side of the optical substrate, with a second optical axis forming a predetermined angle to the first optical axis; and
a package that includes a storage region having a rectangular upper surface and stores the lens and the optical substrate, wherein
the lens and the optical substrate are optically coupled, and disposed in such a way that both the second side and the first optical axis are substantially parallel to one side of the rectangular storage region.

A manufacturing method of an optical module according to the present invention is
a manufacturing method of an optical module that stores, in a package including a storage region having a rectangular upper surface, a lens having a first optical axis and an optical substrate having a rectangular external shape including a first side and a second side forming a right angle to each other, the method including:
forming the optical substrate, in a cross section including the first side, in such a way as to include an optical waveguide that is optically coupled with a second optical axis forming a predetermined angle to the first optical axis;
optically coupling the lens and the optical substrate; and
disposing the optical substrate in such a way that both the second side and the first optical axis are substantially parallel to one side of the rectangular storage region.

### Advantageous Effects of Invention

The present invention provides a technique for reducing a size of an optical module including an optical waveguide.

### BRIEF DESCRIPTION OF DRAWINGS

FIG. 1 is a plan view illustrating an example of an internal configuration of an optical module 100 according to a first example embodiment.

FIG. 2 is a side view illustrating an example of the internal configuration of the optical module 100 according to the first example embodiment.

FIG. 3 is a plan view illustrating an example of an internal configuration of an optical module 200 according to a second example embodiment.

FIG. 4 is a plan view illustrating an example of an internal configuration of an optical module 300 according to a third example embodiment.

FIG. 5 is a plan view illustrating an example of an internal configuration of an optical module 400 according to a fourth example embodiment.

FIG. 6 is a plan view schematically illustrating an internal configuration of a general optical module 900.

### EXAMPLE EMBODIMENT

Example embodiments according to the present invention are described below with reference to the accompanying drawings. A direction of an arrow illustrated in a figure is illustrative and is not intended to limit the direction. According to the example embodiments and the drawings, an already-described element is assigned with the same reference sign, and overlapping description is omitted.

### First Example Embodiment

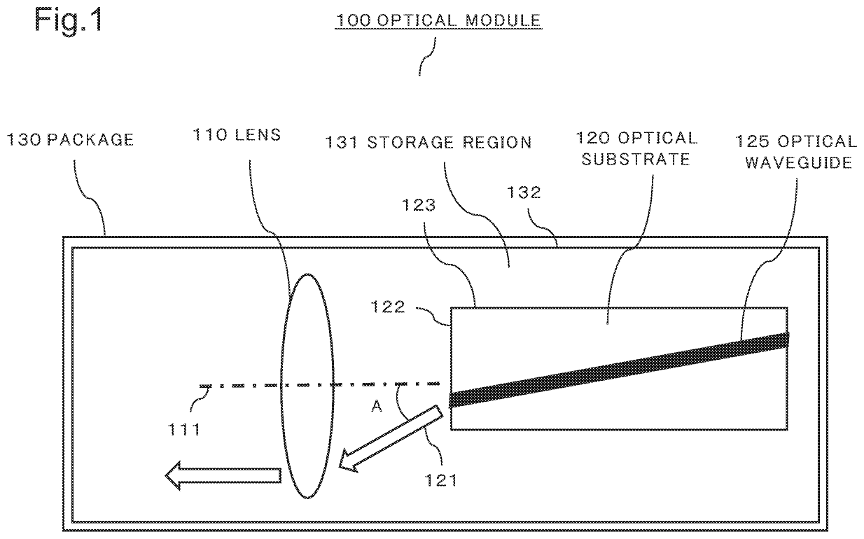

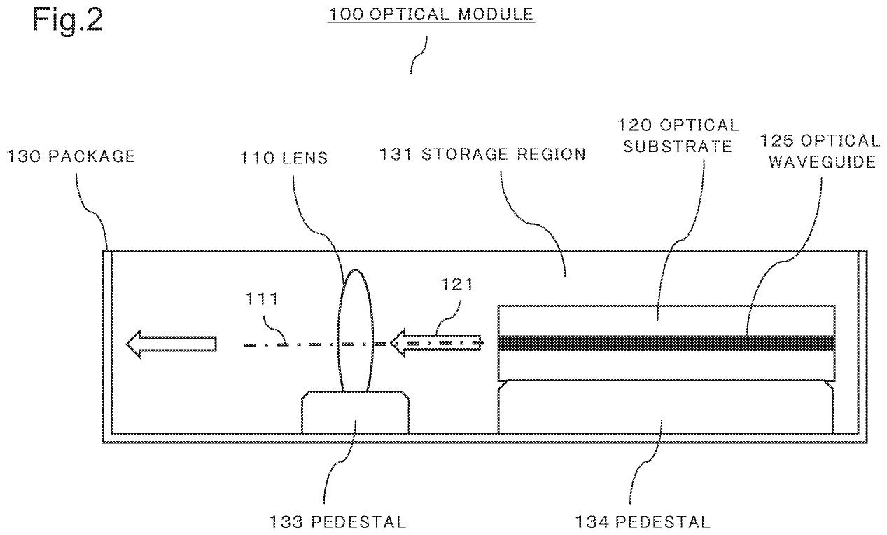

FIG. 1 is a plan view illustrating an example of an internal configuration of an optical module 100 according to a first example embodiment. FIG. 2 is a side view illustrating an example of the internal configuration of the optical module 100 according to the first example embodiment. The optical module 100 includes a lens 110, an optical substrate 120, and a package 130. An optical axis 111 of the lens 110 is illustrated by a dashed-dotted line. The optical substrate 120 is a rectangular substrate including a short side 122 and a long side 123 forming a right angle to the short side 122. The optical substrate 120 is, for example, a semiconductor substrate, and inside the substrate, an optical waveguide 125 is formed. The optical waveguide 125 is formed obliquely to a long side 123 of the optical substrate 120 in a cross section in contact with a short side 122 of the optical substrate 120. In FIG. 1, the long side 123 is drawn in such a way as to be longer than the short side 122. However, the rectangular shape of the optical substrate 120 is not limited to FIG. 1. The optical substrate 120 may be, for example, a square semiconductor substrate. A shape of the optical waveguide 125 other than a cross-sectional portion in contact with the short side 122 is not limited to a straight line. The optical waveguide 125 may have, for example, a curved portion.

The optical waveguide 125 outputs, in short side 122, light generated by the optical waveguide 125 or light input from a cross section of another short side of the optical waveguide 125. An optical axis 121 in FIG. 1 is an optical axis of light output by the optical waveguide 125. The optical axis 121 indicates a direction where light output by the optical waveguide 125 is coupled with an external optical system of the optical waveguide 125 with low loss. Light propagating inside the optical waveguide 125 in a direction of the long side 123 (i.e. a direction from right to left of the optical waveguide 125 in FIG. 1) is emitted in a direction of the optical axis 121 toward the lens 110.

In FIG. 1, the optical axis 121 and an optical axis 111 of the lens 110 form a predetermined angle A. The lens 110 is disposed in the package 130 in such a way as to be optically coupled with the optical axis 121. According to FIG. 2 and the following example embodiments, the optical waveguide 125 is parallel to a bottom surface of the package 130, and heights of the optical axis 121 and the optical axis 111 from the bottom surface of the package 130 coincide with each other.

The package 130 is a housing in which, for example, metal or ceramics is a main material. The package 130 includes, therein, a rectangular storage region 131. The storage region 131 stores the lens 110 and the optical substrate 120. The storage region 131 is, as illustrated in FIG. 1 and FIG. 2, a rectangular parallelepiped space having a depth of the package 130. The storage region 131 is illustrated as a region having a rectangular upper surface in FIG. 1.

The package 130 inputs or outputs light propagating through the optical waveguide 125 between an outside and an inside of the optical module 100. The package 130 may include, for the purpose, a transparent window. Alternatively, the optical module 100 may optically connect an inside and an outside of the package 130, by using an optical fiber penetrating through the package 130. The package 130 may include a terminal electrically connecting an inside and an outside of the optical module 100. Both the lens 110 and the optical substrate 120 are fixed on a bottom surface inside the package 130 by a pedestal 133 and a pedestal 134 illustrated in FIG. 2. In FIG. 1, illustration of the pedestals is omitted. In the package 130, an opening thereof is hermetically sealed by a cover (not illustrated) after necessary components such as the lens 110 and the optical substrate 120 are stored.

In FIG. 1, a long side 132 indicates a long side of the storage region 131. A long side 123 of the optical substrate 120 is disposed in the package 130 in such a way as to be substantially parallel to the long side 132 of the storage region 131. The optical axis 111 of the lens 110 is also disposed in the package 130 in such a way as to be substantially parallel to the long side 132 of the storage region 131. The optical waveguide 125 outputs light in a direction of the optical axis 121, and the light output from the optical waveguide 125 propagates via the lens 110.

By disposing the optical substrate 120 in this manner, the rectangular optical substrate 120 can be efficiently stored in the rectangular storage region 131. In other words, the optical module 100 can reduce a size of an optical module including an optical waveguide. The reason is that both the optical axis 111 of the lens 110 and the long side 123 of the optical substrate 120 are disposed substantially parallel to the long side 132 of the storage region 131 and light output in a direction of the optical axis 121 from the optical waveguide 125 can be optically coupled with the lens 110 having the optical axis 111 forming the predetermined angle A to the optical axis 121. Based on such a configuration, in the optical module 100, even when the optical axis 111 and the optical axis 121 form the predetermined angle A, the optical substrate 120 can be efficiently mounted inside the package 130 since the optical substrate 120 is not disposed obliquely to the package 130.

### Another Description of First Example Embodiment

The configuration of the optical substrate 100 illustrated in FIG. 1 can be described as below. Therefore, the following optical module also exhibits an advantageous same effect as the optical module 100. In parentheses, a reference sign of a relevant component in FIG. 1 is indicated.

An optical module 100 includes a lens 110, an optical substrate 120, an optical waveguide 125 formed in the optical substrate 120, and a package 130.

The lens 110 has a first optical axis 111. The optical substrate 120 has a rectangular shape including a first side 122 and a second side 123 forming a right angle to each other.

The optical waveguide 125 is optically coupled, in a cross section of the optical substrate 120 including the first side 122, with a second optical axis 121 forming a predetermined angle A to the first optical axis 111. The package 130 includes a storage region 131 having a rectangular upper surface. The storage region 131 stores the lens 110 and the optical substrate 120.

The lens 110 and the optical substrate 120 are optically coupled, and the second side 123 of the optical substrate 120 and the first optical axis 111 are disposed in such a way as to be substantially parallel to one side 132 of the rectangular storage region 131.

### Modified Example of First Example Embodiment

The angle A illustrated in FIG. 1 is defined by an angle A preferably considered from a point of view of reducing a coupling loss with the lens 110, while an attenuation amount required for reflection return light to the optical waveguide 125 in an end surface of the optical waveguide 125 is considered. The angle A may be, for example, a nonzero (i.e. not zero) value. In order to reduce a coupling loss between the lens 110 and the optical waveguide 125, the optical waveguide 125 may be designed in such a way that the angle A is equal to or more than 5 degrees and equal to or less than 30 degrees.

In general, as a numeral aperture (NA) of the lens 110 is higher, light propagating along an optical axis forming an angle different from the optical axis 111 of the lens 110 and the lens 110 can be coupled with lower loss. In other words, by increasing the numeral aperture, a coupling loss between the optical waveguide 125 and the lens 110 can be reduced even when the angle A is large. In order to acquire a preferable coupling loss, a numeral aperture of the lens 110 may be equal to or more than 0.5 and equal to or less than 1.

The optical substrate 120 and the lens 110 can be preferably stored in as small a package 130 as possible while accuracy of mounting locations of these components for the storage region 131 is considered. Therefore, an angle formed by the long side 123 of the optical substrate 120 and the long side 132 of the storage region 131 may be equal to or less than 5 degrees. An angle formed by the optical axis 111 of the lens 110 and the long side 132 of the storage region 131 of the package 130 may be equal to or less than 10 degrees.

### Second Example Embodiment

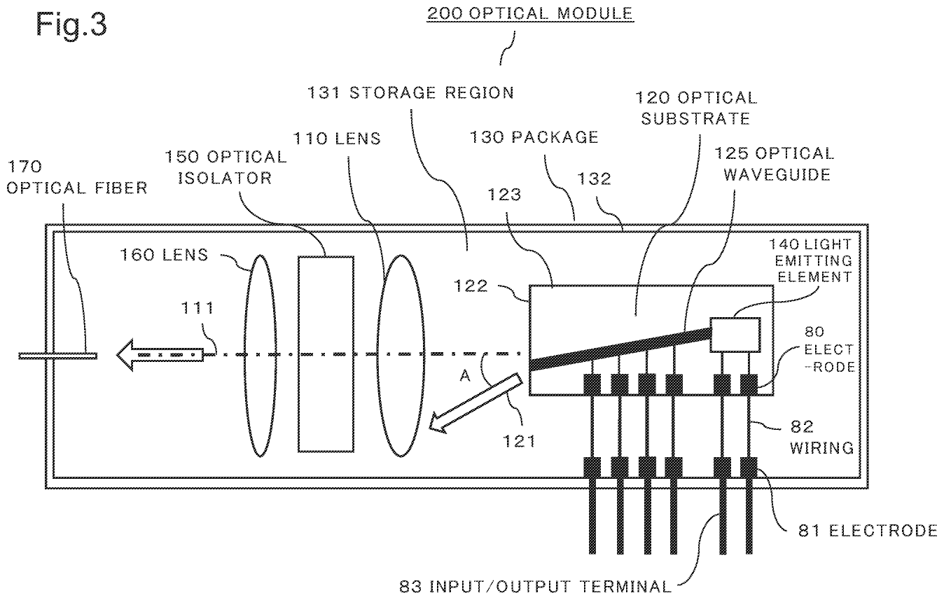

FIG. 3 is a plan view illustrating an example of an internal configuration of an optical module 200 according to a second example embodiment of the present invention. The optical module 200 is a light emitting module mounted with a light emitting element 140. The optical module 200 includes, in addition to the configuration of the optical module 100, a light emitting element 140, an optical isolator 150, a lens 160, and an optical fiber 170.

The optical substrate 120 is a semiconductor substrate, and the optical waveguide 125 is a semiconductor optical waveguide. The optical waveguide 125 includes, for example, functions of an optical resonator, an optical amplifier, and an optical modulator. However, a function of the optical waveguide 125 is not limited to these functions. The light emitting element 140 generates light to be coupled with the optical waveguide 125. The light emitting element 140 is, for example, a laser diode and formed on the optical substrate 120. The light emitting element 140 is driven by drive current supplied from an outside of the optical module 200. Light generated by the light emitting element 140 is input to the optical fiber 170 via the optical waveguide 125, the lens 110, the optical isolator 150, and the lens 160.

Light (transmission light) output in a direction of the optical axis 121 from the optical waveguide 125 is converted into collimated light by the lens 110. The collimated light passes through the optical isolator 150 with low loss. The optical isolator 150 is an optical component optically coupled with the optical waveguide 125 via the lens 110. The optical isolator 150 is provided in order to reduce return light to the light emitting element 140 and stabilize operations of the optical waveguide 125 and the light emitting element 140. The lens 160 couples transmission light passing through the optical isolator 150 with the optical fiber 170. The lens 160 and the lens 110 may be lenses different in specification from each other or lenses having the same specification. The optical fiber 170 is, for example, a single-mode optical fiber and outputs transmission light to an outside of the optical module 200. In other words, the optical fiber 170 is a pigtail fiber of the optical module 200.

When reduction of return light to the light emitting element 140 is not required, the optical isolator 150 may be omitted. When the lens 110 can couple transmission light with the optical fiber 170, the lens 160 may be omitted.

Also, in the optical module 200 including such a configuration, both the optical axis 111 of the lens 110 and the long side 123 of the optical substrate 120 are disposed in such a way as to be substantially parallel to the long side 132 of the storage region 131 in the package 130. Therefore, similarly to the optical module 100, the optical module 200 can reduce a size of an optical module including an optical waveguide.

The optical substrate 120 according to the present example embodiment includes a plurality of electrodes 80, and the package 130 includes a plurality of electrodes 81 and a plurality of input/output terminals 83. The electrodes 80 are provided along the long side 123 of the optical substrate 120, and the electrodes 81 are provided along the long side 132 of the storage region 131. An inside and an outside of the package 130 are electrically connected for each electrode by the electrodes 81 and the input/output terminals 83. The electrodes 80 and the electrodes 81 each are connected by the wirings 82. The wirings 82 are formed, for example, based on wire bonding during manufacturing of the optical module 200. The electrodes 80 are connected to the light emitting element 140 and the optical waveguide 125 by using wiring formed in the optical substrate 120.

The light emitting element 140 and the optical waveguide 125 are driven by an external drive circuit (not illustrated) connected to the input/output terminal 83. The light emitting element 140 emits light, for example, based on drive current applied from a drive circuit to the input/output terminal 83 connected to the light emitting element 140. The optical waveguide 125 operates, for example, as an optical modulator, based on a drive signal applied to the input/output terminal 83 connected to the optical waveguide 125. Herein, as described according to the first example embodiment, the storage region 131 has a rectangular upper surface, and the long side 132 of the surface and the long side 132 of the optical substrate 120 are substantially parallel. Therefore, lengths of the wirings 82 between a plurality of electrodes 80 of the optical substrate 120 and a plurality of electrodes 81 of the package 130 opposite to the electrodes 80 are substantially the same in any wiring.

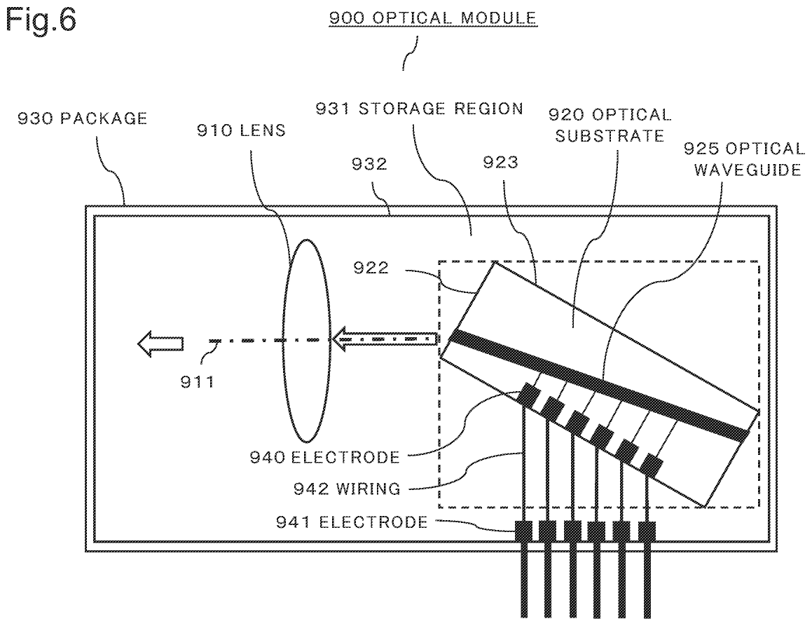

When the optical waveguide 125 is a high-speed optical modulator, a high-speed drive signal for driving the optical waveguide 125 is applied to a plurality of electrodes 80 from an external drive circuit via a plurality of wirings 82. However, as seen in the general optical module 900 illustrated in FIG. 6, when the optical substrate 920 is mounted obliquely to the storage region 931 to a large extent, a distance between the electrode 940 and the electrode 941 (i.e., a length of the wiring 942) is largely different according to locations of the electrodes. This matter causes a variation in delay amount and a variation in inductance among a plurality of drive signals applied to the optical waveguide 925. Such variations in delay amount and inductance in drive signals may cause degradation (i.e. a decrease in quality) of a waveform of an optical signal propagating through the waveguide 925. Also, when the light emitting element 140 is subjected to direct modulation by high-speed drive current, a waveform of an optical signal may degrade due to a difference in wiring length between two wirings 82 connected to the light emitting element.

However, in the optical module 200 according to the present example embodiment, as illustrated in FIG. 3, a long side of the optical substrate 120 is disposed in such a way that a long side of the optical substrate 120 is substantially parallel to the long side 132 of the storage region 131. Therefore, wiring lengths of wirings 82 connecting a plurality of electrodes 80 of the optical substrate 120 and a plurality of electrodes 81 of the package 130 in order to drive the optical waveguide 125 and the light emitting element 140 mounted on the optical substrate 120 can be substantially the same. As a result, the optical module 200 exhibits an advantageous effect in that a decrease in a function of the optical waveguide 125 and a decrease in quality of transmission light due to a difference in wiring length among a plurality of wirings 82 can be reduced.

Wiring lengths from the electrode 80 of the optical substrate 120 to the light emitting element 140 and the optical waveguide 125 are fixed independently of a state where the optical substrate 120 is mounted. Therefore, wiring lengths in the optical substrate 120 can be previously caused to have the same value when the optical substrate 120 is designed.

The light emitting element 140 may be formed an optical substrate different from the optical substrate 120. In this case, the light emitting element 140 and the optical substrate 120 may be disposed closely in such a way as to be directly coupled optically (butt joint). An optical component disposed between the lens 110 and the lens 160 is not limited to the optical isolator 150. Between the lens 110 and the lens 160, one or a plurality of optical components capable of being optically coupled with these lenses may be disposed.

### Third Example Embodiment

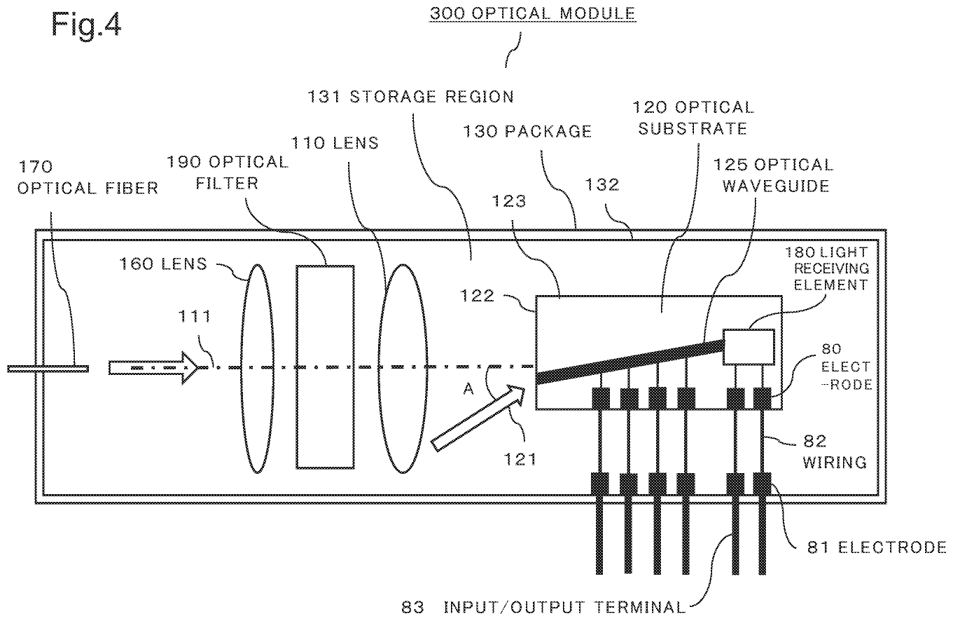

FIG. 4 is a plan view illustrating an example of an internal configuration of an optical module 300 according to a third example embodiment of the present invention. The optical module 300 is a light receiving module mounted with a light receiving element 180. The optical module 300 receives, differently from the optical modules 100 and 200, light from an outside of the optical module 300. The optical module 300 includes, instead of the light emitting element 140 and the optical isolator 150 of the optical module 200, a light receiving element 180 and an optical filter 190. Hereinafter, the optical module 300 is described mainly for a difference from the optical module 200.

Light (received light) input to the optical module 300 from an optical fiber 170 is input to the light receiving element 180 via a lens 160, the optical filter 190, a lens 110, and an optical waveguide 125. The light receiving element 180 is formed on an optical substrate 120. The light receiving element 180 is, for example, a photodiode and converts received light input from the optical waveguide 125 into optical current.

The optical filter 190 is an optical component optically coupled with the optical waveguide 125 via the lens 110. The optical filter 190 transmits only a part of a spectrum of received light and thereby, eliminates light of a wavelength band unnecessary for reception. When elimination of an unnecessary wavelength band included in received light is not required, the optical filter 190 may be omitted. When the lens 110 can be coupled with the optical fiber 170, the lens 160 may be omitted.

In other words, received light may be input to the optical waveguide 125 via only the optical fiber 170 and the lens 110. According to the present example embodiment, a function of the optical waveguide 125 is, for example, an optical attenuator, an optical amplifier, and an optical modulator, but not limited to the example. The optical waveguide 125 is controlled by a control circuit (not illustrated) connected to an input/output terminal 83.

Similarly to the optical modules 100 and 200, a storage region 131 has a rectangular upper surface, and a long side 132 of the region and a long side 123 of an optical substrate 120 are substantially parallel. The long side 132 of the storage region 131 and an optical axis 111 of the lens 110 are substantially parallel. Therefore, the optical module 300 including such a configuration can also, similarly to the optical modules 100 and 200, reduce a size of an optical module including an optical waveguide.

Similarly to the optical module 200 according to the second example embodiment, in the optical module 300, the optical substrate 120 includes a plurality of electrodes 80, and a package 130 includes a plurality of electrodes 81 and a plurality of input/output terminals 83. The light receiving element 180 outputs optical current to an outside of the optical module 300 via the electrode 80, a wiring 82, and the electrode 81.

In the optical module 300, similarly to the optical module 200, distances of the wirings 82 between a plurality of electrodes 80 of the optical substrate 120 and a plurality of electrodes 81 of the package 130 opposite to the electrodes 80 are substantially the same in any wiring. As a result, the optical module 300 exhibits an advantageous effect in that a decrease in quality of optical current due to a difference in wiring length among a plurality of wirings 82 can be reduced, even when high-speed received light is received and even when the optical waveguide 125 is driven at high speed.

The light receiving element 180 may be formed on an optical substrate different from the optical substrate 120. In this case, the light receiving element 180 and the optical substrate 120 may be disposed closely in such a way as to be directly coupled optically. An optical component disposed between the lens 110 and the lens 160 is not limited to the optical filter 190. Between the lens 110 and the lens 160, one or a plurality of optical components capable of being optically coupled with these lenses may be disposed.

### Fourth Example Embodiment

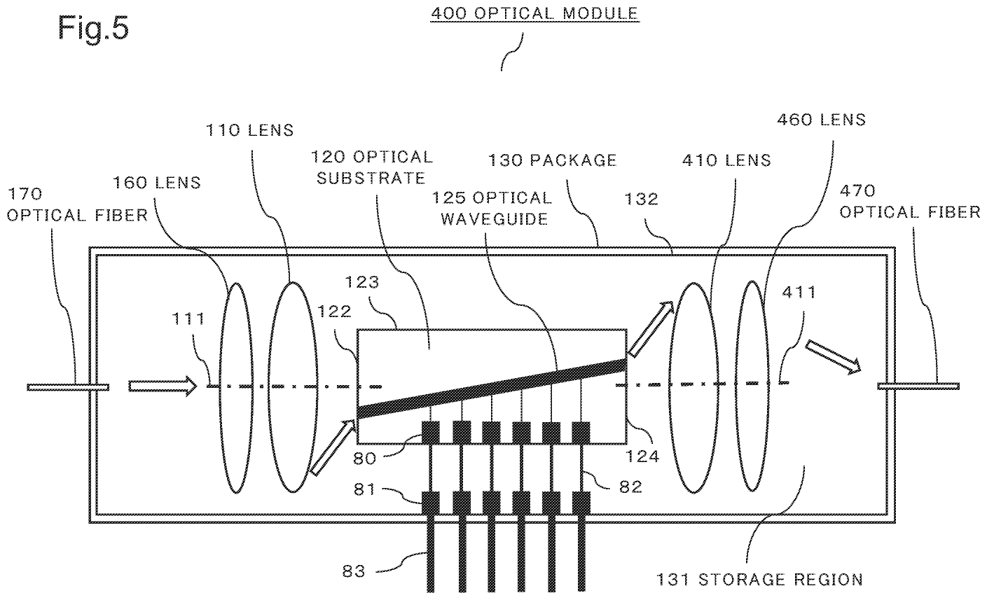

FIG. 5 is a plan view illustrating an example of an internal configuration of an optical module 400 according to a fourth example embodiment of the present invention. The optical module 400 does not include a light emitting element 140 or a light receiving element 180, compared with the optical module 200 in FIG. 3 and the optical module 300 in FIG. 4. The optical module 400 includes a lens 410, a lens 460, and an optical filer 470 on a side of a short side 124 on an opposite side of a short side 122 of an optical substrate 120. The optical fiber 470 is a single-mode optical fiber coupled with the lens 460. The optical module 400 processes, in an optical waveguide 125, light input from an optical fiber 170 and outputs the processed light to the optical fiber 470.

Light input from an outside of the optical module 400 is passed through the lens 160 and the lens 110 and input to the optical waveguide 125 from one cross section of the optical waveguide 125 (i.e. a cross section of the short side 122). Light output from the other cross section of the optical waveguide 125 (i.e. a cross section of the short side 124) is output to an outside of the optical module 400. A function of the optical waveguide 125 is, for example, an optical attenuator, an optical amplifier, a wavelength-tunable optical filter, and an optical modulator, but not limited to the example.

In FIG. 5, an optical axis 411 indicates an optical axis of the lens 410. Specifications of the lenses 410 and 460 may be the same as the specifications of the lenses 110 and 160, respectively. The lens 110 and the lens 160; and the lens 410 and the lens 460 are coupled based on collimated light, respectively. Between the lens 110 and the lens 160 and between the lens 410 and the lens 460, an optical component such as an optical filter and an optical isolator may be provided as necessary. When the lenses 110 and 410 can be coupled with the optical fibers 170 and 470, respectively, without going through another lens, the lenses 160 and 460 may be omitted.

Also, in the optical module 400 including such a configuration, similarly to the optical modules 100, 200, and 300, the storage region 131 has a rectangular upper surface, and a long side 132 of the region and a long side 123 of an optical substrate 120 are substantially parallel. The long side 132 of the storage region 131 and a long side 123 of the optical substrate 120 are substantially parallel. The long side 132 of the storage region 131 and an optical axis 111 of the lens 110 are substantially parallel. The long side 132 of the storage region 131 and the optical axis 411 of the lens 410 are also substantially parallel. Therefore, the optical module 400 can also reduce a size of an optical module including an optical waveguide.

Similarly to the optical modules 200 and 300 according to the second and third example embodiments, in the optical module 400, the optical substrate 120 includes a plurality of electrodes 80, and the package 130 includes a plurality of electrodes 81 and a plurality of input/output terminals 83. The electrode 80 is connected to the optical waveguide 125 by a wiring formed in the optical substrate 120. Therefore, the optical module 400 exhibits, similarly to the optical modules 200 and 300, an advantageous effect in that a decrease in a function of the optical waveguide 125 due to a difference in wiring length among a plurality of wirings 82 can be reduced.

The example embodiments of the present invention can be described as the following supplementary notes, but not limited to the embodiments.

### (Supplementary Note 1)

An optical module including:
a lens having a first optical axis;
an optical substrate having a rectangular external shape including a first side and a second side forming a right angle to each other;
an optical waveguide that is formed on the optical substrate and is optically coupled, in a cross section including the first side of the optical substrate, with a second optical axis forming a predetermined angle to the first optical axis; and
a package that includes a storage region having a rectangular upper surface and stores the lens and the optical substrate, wherein
the lens and the optical substrate are optically coupled, and both the second side and the first optical axis are substantially parallel to one side of the rectangular storage region.

### (Supplementary Note 2)

The optical module according to supplementary note 1, wherein the first optical axis and the second optical axis form a nonzero angle.

### (Supplementary Note 3)

The optical module according to supplementary note 1 or 2, wherein the first optical axis and the second optical axis form an angle equal to or more than 5 degrees and 30 degrees.

### (Supplementary Note 4)

The optical module according to any one of supplementary notes 1 to 3, wherein a numeral aperture of the lens is equal to or more than 0.5 and equal to or less than 1.

### (Supplementary Note 5)

The optical module according to any one of supplementary notes 1 to 4, wherein one side of the rectangular storage region and the second side form an angle equal to or less than 5 degrees.

### (Supplementary Note 6)

The optical module according to any one of supplementary notes 1 to 5, wherein one side of the rectangular storage region and the first optical axis form an angle equal to or less than 10 degrees.

### (Supplementary Note 7)

The optical module according to any one of supplementary notes 1 to 6, further including an optical component optically coupled with the optical waveguide via the lens.

### (Supplementary Note 8)

The optical module according to any one of supplementary notes 1 to 7, wherein the optical substrate includes a light emitting element that generates light to be coupled with the optical waveguide.

### (Supplementary Note 9)

The optical module according to any one of supplementary notes 1 to 8, wherein the optical substrate includes a light receiving element that converts light propagating through the optical waveguide into optical current.

### (Supplementary Note 10)

The optical module according to any one of supplementary notes 1 to 9, wherein
light being input from outside of the package is input to the optical waveguide from one cross section of the optical waveguide, and
light being output from another cross section of the optical waveguide is output to outside of the package.

### (Supplementary Note 11)

The optical module according to any one of supplementary notes 1 to 10, wherein
the optical substrate includes a plurality of first electrodes that drive the optical waveguide,
the package includes a plurality of second electrodes electrically connected to outside of the package, and
each of the plurality of first electrodes and each of the plurality of second electrodes are connected, by using a conductor having a substantially same wiring length.

### (Supplementary Note 12)

A manufacturing method of an optical module that stores, in a package including a storage region having a rectangular upper surface, a lens having a first optical axis and an optical substrate having a rectangular external shape including a first side and a second side forming a right angle to each other, the manufacturing method including:
forming the optical substrate in such a way as to include an optical waveguide optically coupled, in a cross section including the first side, with a second optical axis forming a predetermined angle to the first optical axis;
optically coupling the lens and the optical substrate; and
disposing the optical substrate in such a way that both the second side and the first optical axis are substantially parallel to one side of the rectangular storage region.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The configurations described according to the example embodiments are not necessarily exclusive to each other. The advantageous effect according to the present invention may be achieved by a configuration acquired by combining the whole or a part of the above-described example embodiments.

### REFERENCE SIGNS LIST

80, 81, 940, 941 Electrode
82, 942 Wiring
83 Input/output terminal
100, 200, 300, 400, 900 Optical module
110, 160, 410, 460, 910 Lens
111, 411, 911 Optical axis
120, 920 Optical substrate
121 Optical axis
122, 124, 922 Short side
123, 132, 923, 932 Long side
125, 925 Optical waveguide
130, 930 Package
130, 931 Storage region
133, 134 Pedestal
140 Light emitting element
150 Optical isolator
170, 470 Optical fiber
180 Light receiving element
190 Optical filter
900 Optical module

What is claimed is:

1. An optical module comprising:
a lens having a first optical axis;
an optical substrate having a rectangular external shape including a first side and a second side forming a right angle to each other;
an optical waveguide that is formed on the optical substrate and is optically coupled, in a cross section including the first side of the optical substrate, with a second optical axis forming a predetermined angle to the first optical axis; and
a package that includes a storage region having a rectangular upper surface and stores the lens and the optical substrate, wherein
the lens and the optical substrate are optically coupled, and both the second side and the first optical axis are substantially parallel to one side of the rectangular storage region.

2. The optical module according to claim 1, wherein the first optical axis and the second optical axis form a nonzero angle.

3. The optical module according to claim 1, wherein the first optical axis and the second optical axis form an angle equal to or more than 5 degrees and equal to or less than 30 degrees.

4. The optical module according to claim 1, wherein a numeral aperture of the lens is equal to or more than 0.5 and equal to or less than 1.

5. The optical module according to claim 1, wherein one side of the rectangular storage region and the second side form an angle equal to or less than 5 degrees.

6. The optical module according to claim 1, wherein one side of the rectangular storage region and the first optical axis form an angle equal to or less than 10 degrees.

7. The optical module according to claim 1, further comprising an optical component optically coupled with the optical waveguide via the lens.

8. The optical module according to claim 1, wherein the optical substrate includes a light emitting element that generates light to be coupled with the optical waveguide.

9. The optical module according to claim 1, wherein the optical substrate includes a light receiving element that converts light propagating through the optical waveguide into optical current.

10. The optical module according to claim 1, wherein
light being input from outside of the package is input to the optical waveguide from one cross section of the optical waveguide, and
light being output from another cross section of the optical waveguide is output to outside of the package.

11. The optical module according to claim 1, wherein
the optical substrate includes a plurality of first electrodes that drive the optical waveguide,
the package includes a plurality of second electrodes electrically connected to outside of the package, and
each of the plurality of first electrodes and each of the plurality of second electrodes are connected, by using a conductor having a substantially same wiring length.

12. A manufacturing method of an optical module that stores, in a package including a storage region having a rectangular upper surface, a lens having a first optical axis and an optical substrate having a rectangular external shape including a first side and a second side forming a right angle to each other, the manufacturing method comprising:
forming the optical substrate in such a way as to include an optical waveguide optically coupled, in a cross section including the first side, with a second optical axis forming a predetermined angle to the first optical axis;
optically coupling the lens and the optical substrate; and
disposing the optical substrate in such a way that both the second side and the first optical axis are substantially parallel to one side of the rectangular storage region.
